(19) United States
(12) Patent Application Publication
(10) Pub. No.: US 2013/0027484 A1
(43) Pub. Date: Jan. 31, 2013

(54) INKJET RECORDING APPARATUS

(71) Applicant: Takashi FUKUI, Ashigarakami-gun (JP)

(72) Inventor: Takashi FUKUI, Ashigarakami-gun (JP)

(21) Appl. No.: 13/550,964

(22) Filed: Jul. 17, 2012

(30) Foreign Application Priority Data
Jul. 29, 2011 (JP) NO. 2011-167276

(51) Int. Cl. B41J 2/01; B41J 2/17

(52) U.S. Cl. 347/93; 347/102

(57) ABSTRACT

An aspect of the present invention provides an inkjet recording apparatus, including: an image recording section which records an image on a front surface of a cut sheet recording medium by an inkjet method using an aqueous ink; a chain gripper which receives the recording medium, on the front surface of which an image has been recorded, from the image recording section, and conveys the recording medium by gripping a leading end of the received recording medium; and a drying processing section which carries out a drying process on the recording medium conveyed by the chain gripper.

### BACKGROUND OF THE INVENTION

1. Field of the Invention

The present invention relates to an inkjet recording apparatus, and more particularly, to an inkjet recording apparatus which records an image using aqueous UV ink.

2. Description of the Related Art

An aqueous UV inkjet recording apparatus which records an image by an inkjet method using UV (ultraviolet)-curable ink based on an aqueous medium (aqueous UV ink) is known (see, for example, Japanese Patent Application Publication No. 2011-46872).

In an aqueous UV inkjet recording apparatus, in order to fix the image that has been formed, processing for irradiating the image after image formation with UV (ultraviolet light) is required. Furthermore, if using a generic printing paper (namely, a paper which is principally constituted by cellulose, such as coated paper, which is used in general offset printing, rather than special inkjet paper), then a drying process is also required after image formation.

In order to carry out this UV irradiation process and drying process, in Japanese Patent Application Publication No. 2011-37195, in an inkjet recording apparatus which conveys paper by drums, a conveyance drum for drying is arranged after a conveyance drum for image formation, the paper after image formation is subjected to a drying process by a drying apparatus which is provided at the periphery of the conveyance drum for drying, and furthermore, a conveyance drum for fixing is provided after the conveyance drum for drying and a UV irradiation process is carried out by a UV irradiation apparatus which is provided at the periphery of the conveyance drum for fixing.

Moreover, in Japanese Patent Application Publication No. 2010-76872, an inkjet recording apparatus which conveys paper by drums adopts a composition in which a drying apparatus is provided together with an inkjet head at the periphery of a conveyance drum for image formation, and paper after image formation is subjected to a drying process by this drying apparatus. While the paper which has undergone this drying process is being output by the chain gripper, a UV irradiation process is carried out by using a UV lamp which is incorporated inside the chain gripper.

Furthermore, in Japanese Patent Application Publication No. 2006-305773, an inkjet recording apparatus which conveys paper by belts is composed in such a manner that an inkjet head, a heater and a UV lamp are provided in a paper conveyance path based on a conveyance belt, and paper after image formation successively undergoes a UV irradiation process and a drying process.

However, when paper is subjected to a drying process, in a composition where the paper is conveyed by drums and a drying apparatus is arranged on the conveyance path, as in Japanese Patent Application Publication No. 2011-37195, there is a limit on the number of drying apparatuses which can be installed, and it is difficult to dry the paper rapidly and efficiently. In other words, in order to dry paper after image formation, rapidly and efficiently, it is necessary to arrange a plurality of drying apparatuses at high density, but in order to arrange a plurality of drying apparatuses at high density, the diameter of the conveyance drum must be made large and the apparatus becomes large in size.

Moreover, desirably, the paper after image formation is subjected to a drying process straight away, but if a drying apparatus is provided in the conveyance path by a conveyance drum for image formation, as in Japanese Patent Application Publication No. 2010-76872, the conveyance drum is heated up by heat generated during the drying process, the inkjet head is dried by the heat of the conveyance drum, and there is a risk of decline in the droplet ejection accuracy.

Similarly, in Japanese Patent Application Publication No. 2006-305773, the conveyance belt is heated by the drying heat, the inkjet head is dried by the heat of this conveyance belt, and there is a risk of decline in the droplet ejection accuracy.

### SUMMARY OF THE INVENTION

The present invention was devised in view of these circumstances, an object thereof being to provide an inkjet recording apparatus which is capable of efficiently carrying out a drying process.

The means for solving the problems are described below.

[1] A first mode of the present invention is an inkjet recording apparatus, comprising: an image recording section which records an image on a front surface of a cut sheet recording medium by an inkjet method using an aqueous ink; a chain gripper which receives the recording medium, on the front surface of which an image has been recorded, from the image recording section, and conveys the recording medium by gripping a leading end of the received recording medium; and a drying processing section which carries out a drying process on the recording medium conveyed by the chain gripper.

According to the first mode, a recording medium on the front surface of which an image has been recorded by an image recording section is transferred to a chain gripper, and is conveyed along a prescribed conveyance path while the leading end of the paper is gripped. A drying process is carried out during the course of this conveyance. The paper conveyance path in the chain gripper can be set freely, and the length of the drying processing section can be set as desired. Furthermore, a drying process can be carried out while the paper is conveyed along a flat guide plate. Therefore, it is possible to dry the recording medium rapidly and efficiently after an image has been recorded, and hence deformation of the paper is suppressed and an image of high quality can be recorded. Moreover, increase in the temperature of the image recording section due to the heat generated during drying can be restricted.

[2] A second mode of the present invention is the inkjet recording apparatus as defined in the first mode, further comprising a UV irradiation processing section which carries out a UV irradiation process after the drying process on the recording medium conveyed by the chain gripper, wherein the aqueous ink used in the image recording section is a UV-curable type of aqueous ink.

According to the second mode, in the image recording section, image recording is carried out using a UV (ultraviolet light)-curable aqueous ink (aqueous UV ink). If using a UV-curable ink, a UV (ultraviolet light) irradiation process is required after image recording. In the present mode, a UV irradiation process is carried out during the course of conveyance by the chain gripper. More specifically, in the present mode, a drying process and a UV irradiation process are carried out during the course of conveyance by the chain gripper. As stated above, the paper conveyance path in the chain gripper can be set freely, and the length of the drying processing section and the UV irradiation section can be set as desired. Therefore, it is possible to dry the recording medium rapidly and efficiently after an image has been recorded, and hence deformation of the paper is suppressed and an image of high quality can be recorded. Moreover, increase in the temperature of the image recording section due to the heat generated during drying and UV irradiation can be suppressed.

[3] A third mode of the present invention is the inkjet recording apparatus as defined in the first or the second mode, further comprising a back tension application device which applies a back tension to the recording medium conveyed by the chain gripper.

According to the third mode, when conveying a recording medium by a chain gripper, it is possible to apply a back tension to the recording medium. Consequently, a drying process and a UV irradiation process can be carried out while applying a back tension to the recording medium, and therefore deformation of the paper can be further suppressed.

[4] A fourth mode of the present invention is the inkjet recording apparatus as defined in the third mode, wherein the back tension application device comprises: a guide plate which is arranged along a conveyance path of the recording medium conveyed by the chain gripper, and over which a rear surface of the recording medium conveyed by the chain gripper slides, and which has a plurality of suction holes in the sliding surface over which the recording medium slides; and a suctioning device which suctions the rear surface of the recording medium that slides over the sliding surface of the guide plate, by suctioning air from the suction holes of the guide plate.

According to the fourth mode, a guide plate is arranged along the conveyance path of the recording medium. The rear surface (the surface on the opposite side to the surface on which the image has been recorded (front surface)) slides over the guide plate while the recording medium is conveyed with the leading end thereof gripped by the chain gripper. On the other hand, a plurality of suction holes are formed in the guide plate and air is suctioned from these suction holes. By this means, the rear surface of the recording medium which slides over the guide plate is suctioned to the guide plate. Consequently, a back tension is applied to the recording medium conveyed by the chain gripper.

[5] A fifth mode of the present invention is the inkjet recording apparatus as defined in any one of the first to fourth mode, wherein the drying processing section comprises: a drying process device which carries out a drying process on the recording medium, by heating and/or a warm air flow; and an exhaust device.

According to the fifth mode, the drying processing section comprises a drying processing device which carries out a drying process on the recording medium by heating and/or a warm air flow, and an exhaust device. The recording medium conveyed by the chain gripper undergoes a drying process by the heating and/or warm air flow. Furthermore, humid air generating during the drying process is expelled by the exhaust device. Consequently, it is possible to dry the recording medium efficiently. The number of drying processing devices and exhaust devices can be increased or reduced as necessary. In this case, the length of the chain gripper for conveying the paper through the drying processing section is adjusted in accordance with the number of drying processing device and exhaust devices.

[6] A sixth mode of the present invention is the inkjet recording apparatus as defined in the fifth mode, wherein the drying processing section carries out a drying process on the recording medium by using a heat source which heats only a pigment or dye in the aqueous ink.

According to the sixth mode, if a drying process is carried out by heating the recording medium by a heating device, then a heat source which heats only the pigment or dye in the aqueous ink is used. Consequently, it is possible to suppress deformation of the recording medium which is generated by heating of the recording medium.

[7] A seventh mode of the present invention is the inkjet recording apparatus as defined in any one of the second to the sixth mode, further comprising a heat expelling device which expels heat generated by a UV light source of the UV irradiation processing section, to the drying processing section.

According to the seventh mode, the heat generated by the UV light source of the UV irradiation processing section is expelled to the drying processing section and contributes to drying. Therefore, it is possible to dry the paper efficiently, as well as saving power.

[8] An eighth mode of the present invention is the inkjet recording apparatus as defined in the seventh aspect, wherein the UV irradiation processing section uses an ozone-less type light source.

According to the eighth mode, when carrying out a UV irradiation process in a UV irradiation processing section, an ozone-less type of light source is used. Consequently, it is possible to carry out a UV irradiation process without producing harmful ozone. Furthermore, for example, if the heat generated by the UV light source is expelled to the drying processing section, then stable operation is possible, even if the heat is expelled by air blowing.

[9] A ninth mode of the present invention is the inkjet recording apparatus as defined in any one of the second to the eighth mode, wherein the drying processing section and the UV irradiation processing section are arranged inside the chain gripper.

According to the ninth mode, the drying processing section and the UV irradiation processing section are arranged inside the chain gripper. Consequently, the apparatus can be made more compact.

[10] A tenth mode of the present invention is the inkjet recording apparatus as defined in any one of the first to the ninth mode, wherein the image recording section comprises: a conveyance drum which suctions and holds the recording medium on a circumferential surface of the conveyance drum and conveys the recording medium; and an inkjet head which records an image by ejecting the aqueous ink onto a front surface of the recording medium which is conveyed by the conveyance drum, and wherein the chain gripper receives the recording medium from the conveyance drum.

According to the tenth mode, image recording is carried out while the recording medium is conveyed on a drum in the image recording section. Since the recording medium is conveyed while being suctioned and held on a circumferential surface of a conveyance drum, then it is possible to convey the recording medium at high speed in a highly flat state, and an image of high quality can be recorded at high speed. Furthermore, since the recording medium on which an image has been recorded is received on the chain gripper from the conveyance drum, and a drying process is carried out immediately, then it is possible to suppress deformation of the paper. Moreover, since the drying process section and the image recording section are separated, then it is possible to suppress increase in the temperature of the image recording section due to heat generated in the drying processing section. In particular, since the conveyance drum can be prevented from directly receiving the heat of the drying processing section, then it is possible to record images of high quality in a stable fashion.

[11] An eleventh mode of the present invention is the inkjet recording apparatus as defined in the tenth mode, wherein the image recording section further comprises an image reading device which reads an image recorded on the front surface of the recording medium by the inkjet head.

According to the eleventh mode, the image recording section comprises an image reading device which reads in a recorded image. In this way, by providing an image reading device in the image recording section and reading in an image directly after recording by the inkjet head, while on the conveyance drum, it is possible to read in an image with good accuracy. More specifically, since the conveyance drum conveys the recording medium while suctioning and holding the recording medium on a circumferential surface, it is possible to convey the recording medium in a highly flat state, and the image can be read with the paper in a state free of deformation. Furthermore, since an image is read from the recording medium in the same state as when the image was recorded, then the image can be read with high accuracy (in other words, the image can be read with high accuracy, since the recording medium is not transferred to another conveyance system, but rather is read while on the same conveyance drum). Moreover, since the image can be read immediately after image recording, then it is possible to detect an abnormality straight away when, for instance, a printing abnormality is detected in the read image. Accordingly, wasteful consumption of the recording medium can be prevented.

[12] A twelfth mode of the present invention is the inkjet recording apparatus as defined in the eleventh mode, wherein the image recording section further comprises a mist filter provided between the inkjet head and the image reading device.

According to the twelfth mode, a mist filter is provided between the inkjet head and the image reading device. Consequently, it is possible to prevent the occurrence of reading faults or decline in reading accuracy in the image reading device, or the like, as a result of the ink mist generated by the inkjet head.

[13] A thirteenth mode of the present invention is the inkjet recording apparatus as defined in one of the tenth and the eleventh mode, wherein the image recording section further comprises a cooling device which cools the conveyance drum.

According to the thirteenth mode, a cooling device which cools the conveyance drum in the image recording section is provided. Therefore, it is possible to restrict increase in the temperature of the conveyance drum of the image recording section, even if this conveyance drum receives heat from the drying process section. Consequently, it is possible to prevent condensation from being caused in the inkjet head due to the conveyance drum having a higher temperature than the inkjet head.

[14] A fourteenth mode of the present invention is the inkjet recording apparatus as defined in one of the first to the thirteenth mode, further comprising: a treatment liquid deposition section which deposits a treatment liquid having a function of aggregating coloring material in the aqueous ink, on the front surface of the recording medium; and a treatment liquid drying processing section which carries out a drying process on the recording medium on which the treatment liquid has been deposited, wherein the image recording section receives the recording medium on which a drying process has been carried out by the treatment liquid drying processing section, and records an image thereon by an inkjet method in use of the aqueous ink.

According to the fourteenth mode, a treatment liquid deposition section which deposits treatment liquid having a function of aggregating the coloring material in the aqueous ink, and a treatment liquid drying processing section which carries out a drying process on the recording medium on which the treatment liquid has been deposited, are provided before the image recording section. Consequently, it is possible to record images of high quality, even if using generic printing paper as the recording medium.

According to the present invention, it is possible to carry out a drying process efficiently after image formation.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a general schematic drawing showing one embodiment of an inkjet recording apparatus according to the present invention; and

FIG. 2 is a block diagram showing the general composition of a control system of an inkjet recording apparatus.

### DESCRIPTION OF THE PREFERRED EMBODIMENTS

### Composition of Apparatus

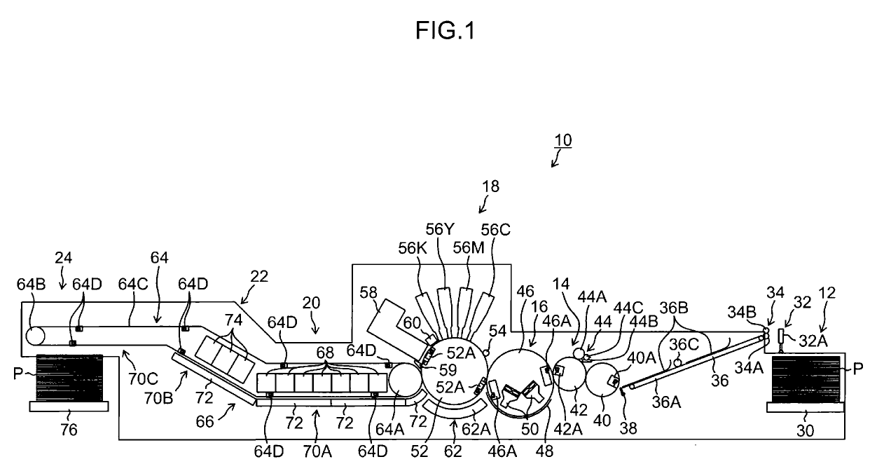

FIG. 1 is a general schematic drawing showing one embodiment of an inkjet recording apparatus relating to the present invention.

This inkjet recording apparatus 10 is an inkjet recording apparatus which records an image by an inkjet method using aqueous UV ink (UV (ultraviolet light)-curable ink using an aqueous medium) on cut sheet paper (recording media) P, and principally comprises: a paper supply section 12 which supplies paper P; a treatment liquid deposition section 14 which deposits a prescribed treatment liquid onto a front surface (image recording surface) of paper P which has been supplied from the paper supply section 12; a treatment liquid drying processing section 16 which carries out a drying process of the paper P on which treatment liquid has been deposited by the treatment liquid deposition section 14; an image recording section 18 which records an image by an inkjet method using aqueous UV ink on the front surface of the paper P on which a drying process has been carried out by the treatment liquid drying processing section 16; an ink drying processing section 20 which carries out a drying process on the paper P on which an image has been recorded by the image recording section 18; a UV irradiation processing section 22 which fixes an image by carrying out a UV irradiation process (fixing process) on the paper P which has undergone a drying process in the ink drying process section 20; and a paper output section 24 which outputs paper P which has undergone a UV irradiation process in the UV irradiation processing section 22.

(Paper Supply Section)

The paper supply section 12 supplies paper P which is stacked on a paper supply tray 30, one sheet at a time, to the treatment liquid deposition section 14. The paper supply section 12 is principally constituted by a paper supply tray 30, a sucker apparatus 32, a paper supply roller pair 34, a feeder board 36, a front rail 38 and a paper supply drum 40.

The paper P is loaded onto the paper supply tray 30 in the form of a stack of many sheets of paper P layered together. The paper supply tray 30 is provided raisably and lowerably by means of a paper supply tray elevator apparatus, which is not illustrated. The paper supply tray elevator apparatus is driven in coordination with increase or decrease in the amount of paper P stacked on the paper supply tray 30 and raises and lowers the paper supply tray 30 in such a manner that the paper P position at the top of the stack is always at a constant height.

The paper P forming the recording medium is not limited in particular, but it is possible to use generic printing paper which is used in general offset printing, or the like, (paper which is principally made of cellulose, such as so-called top-grade paper, coated paper, art paper, and the like). In the present embodiment, coated paper is used. Coated paper is high-grade or medium-grade paper which does not generally have a surface treatment and which has a coating layer provided on the surface thereof by applying a coating material. More specifically, art paper, coated paper, lightweight coated paper or fine coated paper are desirable papers to use.

The sucker apparatus 32 picks up paper P stacked on the paper supply tray 30, one sheet at a time, successively from the top, and supplies the paper P to the paper supply roller pair 34. The sucker apparatus 32 comprises a suction foot 32A which is provided raisably and lowerably, and swingably, and the upper surface of the paper P is suctioned and held by this suction foot 32A and the paper P is moved from the paper supply tray 30 to the paper supply roller pair 34. In this case, the suction foot 32A suctions and holds the upper surface of the leading end side of the paper P which is positioned at the top of the stack, lifts up the paper P, and introduces the leading end of the lifted paper P in between the pair of rollers 34A, 34B which constitute the paper supply roller pair 34.

The paper supply roller pair 34 are constituted by an upper and lower pair of rollers 34A, 34B which are abutted and pressed against each other. One of the upper and lower pair of rollers 34A, 34B is a drive roller (roller 34A) and the other thereof is an idle roller (roller 34B). The driver roller (roller 34A) is driven by a motor (not illustrated) so as to rotate. The motor is driven in coordination with the supply of paper P, and when the paper P is supplied from the sucker apparatus 32, the drive roller (roller 34A) is caused to rotate in accordance with this timing. The paper P which has been introduced between the upper and lower pair of rollers 34A, 34B is nipped by the rollers 34A, 34B and is paid out in the direction of rotation of the rollers 34A, 34B (the direction of installation of the feeder board 36).

The feeder board 36 is formed so as to correspond to the paper width, and receives the paper P paid out from the paper supply roller pair 34 and guides the paper P to the front rail 38. This feeder board 36 is provided at an inclination with the front end side thereof tilted downwards, and the paper P loaded on the conveyance surface slides along the conveyance surface and is guided to the front rail 38.

A plurality of tape feeders 36A for conveying the paper P are provided in the feeder board 36, at a spacing apart in the width direction. The tape feeder 36A is formed in an endless fashion, and is caused to rotate by being driven by a motor (not illustrated). The paper P which is loaded on the conveyance surface of the feeder board 36 receives movement from this tape feeder 36A, and is conveyed over the feeder board 36.

Furthermore, retainers 36B and a roller 36C are provided on top of the feeder board 36.

A plurality of the retainers 36B are arranged in front/rear alignment along the conveyance surface of the paper P (in the present embodiment, there are two retainers). The retainers 36B are each constituted by a plate spring having a width corresponding to the paper width, and are abutted and pressed against the conveyance surface. Indentations in the paper P conveyed over the feeder board 36 by the tape feeder 36A are corrected by passing the retainers 36B. The retainers 36B are formed in such a manner that paper P can be introduced readily between the retainer and the feeder board 36, and therefore the rear end portion is formed with a curl.

The roller 36C is arranged between the front and rear retainers 36B. The roller 36C is arranged so as to be abutted and pressed against the conveyance surface of the paper P. The paper P which is conveyed between the front and rear retainers 36B is conveyed while the upper surface thereof is restricted by this roller 36C.

The front rail 38 corrects the attitude of the paper P. This front rail 38 is formed in a plate shape and is arranged perpendicularly with respect to the conveyance direction of the paper P. Furthermore, the front rail 38 is driven by a motor (not illustrated) and is provided swingably. The leading end of the paper P which is conveyed over the feeder board 36 abuts against the front rail 38 and the attitude is corrected (namely, skew is prevented). The front rail 38 swings in coordination with the supply of paper to the paper supply drum 40, and paper P having a corrected attitude is transferred onto the paper supply drum 40.

The paper supply drum 40 receives the paper P supplied from the feeder board 36 via the front rail 38 and is conveyed to the treatment liquid deposition section 14. The paper supply drum 40 is formed in a round cylindrical shape and is caused to rotate by being driven by a motor (not illustrated). A gripper 40A is provided on the outer circumferential surface of the paper supply drum 40, and the leading end of the paper P is gripped by this gripper 40A. The paper supply drum 40 conveys the paper P to the treatment liquid deposition section 14 while the paper P is wrapped about the circumferential surface of the drum, by gripping the leading end of the paper P with the gripper 40A and rotating.

The paper supply apparatus 12 has the composition described above. The paper P stacked on the paper supply platform 30 is lifted up successively from the top, one sheet at a time, by the sucker apparatus 32, and is supplied to the paper supply roller pair 34. The paper P which has been supplied to the paper supply roller pair 34 is paid out forwards by the upper and lower pair of rollers 34A, 34B which constitute the paper supply roller pair 34, and is loaded onto the feeder board 36. The paper P which is loaded onto the feeder board 36 is conveyed by the tape feeder 36A provided on the conveyance surface of the feeder board 36. During the course of this conveyance, the paper P is pressed against the conveyance surface of the feeder board 36 by the retainers 36B and indentations in the paper P are corrected. The leading end of the paper P which has been conveyed by the feeder board 36 is abutted against the front rail 38, the skew thereof is corrected, and the paper P is then transferred onto the paper supply drum 40. The paper P is then conveyed to the treatment liquid deposition section 14 by the paper supply drum 40.

(Treatment Liquid Deposition Section)

The treatment liquid deposition section 14 deposits a prescribed treatment liquid onto the front surface (image recording surface) of the paper P. This treatment liquid deposition section 14 is principally constituted by a treatment liquid deposition drum 42 which conveys the paper P, and a treatment liquid deposition unit 44 which deposits a prescribed treatment liquid onto the printing surface of the paper P which is conveyed by the treatment liquid deposition drum 42.

The treatment liquid deposition drum 42 receives the paper P from the paper supply drum 40 of the paper supply section 12 and conveys the paper P to the treatment liquid drying processing section 16. The treatment liquid deposition drum 42 is formed in a round cylindrical shape and is caused to rotate by being driven by a motor (not illustrated). A gripper 42A is provided on the outer circumferential surface of the treatment liquid deposition drum 42, and the leading end of the paper P is gripped by this gripper 42A. The treatment liquid deposition drum 42 conveys the paper P to the treatment liquid drying processing section 16 (one sheet of paper P is conveyed in one revolution) while the paper P is wrapped about the circumferential surface of the drum, by gripping the leading end of the paper P by the gripper 42A and rotating. The rotation of the treatment liquid deposition drum 42 and the paper supply drum 40 is controlled in such a manner that the reception timing and transfer timing of the paper P are matching. In other words, the drums are driven so as to have the same circumferential speed, and are also driven in such a manner that the positions of the respective grippers match each other.

The treatment liquid deposition unit 44 applies a treatment liquid by roller onto the front surface of the paper P which is conveyed by the treatment liquid deposition drum 42. This treatment liquid deposition unit 44 principally comprises an application roller 44A which applies treatment liquid to the paper P, a treatment liquid tank 44B in which treatment liquid is stored, and a take-up roller 44C which takes up treatment liquid stored in the treatment liquid tank 44B and supplies the treatment liquid to the application roller 44A. The take-up roller 44C is provided so as to abut and press against the application roller 44A, and is also provided in such a manner that a portion thereof is immersed in the treatment liquid stored in the treatment liquid tank 44B. The take-up roller 44C doses and takes up the treatment liquid, and applies the treatment liquid at a constant thickness to the circumferential surface of the application roller 44A. The application roller 44A is provided so as to correspond to the paper width, and by abutting and pressing against the paper P, applies the treatment liquid adhering to the circumferential surface thereof, to the paper P. The application roller 44A is driven by an abutting and separating mechanism (not illustrated), and is moved between an abutting position of abutting against the circumferential surface of the treatment liquid deposition drum 42 and a separated position which is separated from the circumferential surface of the treatment liquid deposition drum 42. The abutting and separating mechanism moves the application roller 44A in accordance with the passage timing of the paper P, and applies treatment liquid to the front surface of the paper P which is conveyed by the treatment liquid deposition drum 42.

In the present example, a composition which applies the treatment liquid by roller is adopted, but the method of depositing the treatment liquid is not limited to this. Additionally, it is also possible to adopt a composition which applies treatment liquid by using an inkjet head or by means of a spray.

The treatment liquid deposition section 14 has the composition described above. The paper P transferred from the paper supply drum 40 of the paper supply section 12 is received by the treatment liquid deposition drum 42. The treatment liquid deposition drum 42 grips the leading end of the paper P, with the gripper 42A, and by rotating, wraps the paper P about the circumferential surface thereof and conveys the paper P. During the course of this conveyance, the application roller 44A is abutted and pressed against the front surface of the paper P, and treatment liquid is applied to the front surface of the paper P.

Here, the treatment liquid applied to the front surface of the paper P is a treatment liquid which has a function of aggregating the coloring material in the aqueous UV ink ejected in the form of droplets onto the paper P by an image recording section 18 in a subsequent stage. By applying treatment liquid of this kind to the front surface of the paper P and ejecting droplets of aqueous UV ink, it is possible to carry out printing of high quality, without the occurrence of landing interference, or the like, even when using generic printing paper.

(Treatment Liquid Drying Processing Section)

The treatment liquid drying processing section 16 carries out a drying process on the paper P on the front surface of which treatment liquid has been deposited. The treatment liquid drying processing section 16 is mainly constituted by a treatment liquid drying processing drum 46 which conveys paper P, a paper conveyance guide 48, and a treatment liquid drying processing unit 50 which dries the paper P by blowing a warm air flow onto the printing surface of the paper P which is conveyed by the treatment liquid drying processing drum 46.

The treatment liquid drying processing drum 46 receives the paper P from the treatment liquid deposition drum 42 of the treatment liquid deposition section 14 and conveys the paper P to the image recording section 18. The treatment liquid drying processing drum 46 is a frame formed into a round cylindrical shape and is caused to rotate by being driven by a motor (not illustrated). A gripper 46A is provided on the outer circumferential surface of the treatment liquid drying processing drum 46, and the leading end of the paper P is gripped by this gripper 46A. The treatment liquid drying processing drum 46 conveys the paper P to the image recording section 18 by gripping the leading end of the paper P by the gripper 46A and rotating. The treatment liquid drying processing drum 46 according to the present embodiment is composed in such a manner that grippers 42A are provided in two positions on the outer circumferential surface, whereby two sheets of paper P can be conveyed in one revolution. The rotation of the treatment liquid drying processing drum 46 and the treatment liquid deposition drum 42 is controlled in such a manner that the reception timing and transfer timing of the paper P are matching. In other words, the drums are driven so as to have the same circumferential speed, and are also driven in such a manner that the positions of the respective grippers match each other.

The paper conveyance guide 48 is provided along the conveyance path of the paper P by the treatment liquid drying processing drum 46, and guides the conveyance of the paper P.

The treatment liquid drying processing unit 50 is disposed on the inside of the treatment liquid drying processing drum 46 and carries out a drying process by blowing a warm air flow towards the front surface of the paper P which is conveyed by the treatment liquid drying processing drum 46. In the present embodiment, two treatment liquid drying processing units 50 are provided inside the treatment liquid drying processing drum, and the warm air flow is blown toward the front surface of the paper P conveyed by the treatment liquid drying processing drum 46.

The treatment liquid drying processing section 16 has the composition described above. The paper P transferred from the treatment liquid deposition drum 42 of the treatment liquid deposition section 14 is received by the treatment liquid drying processing drum 46. The treatment liquid drying processing drum 46 grips the leading end of the paper P, with the gripper 46A, and by rotating, conveys the paper P. In this case, the treatment liquid drying processing drum 46 conveys the paper P with the front surface (the surface on which the treatment liquid has been applied) facing inwards. During the conveyance of the paper P by the treatment liquid drying processing drum 46, the paper P undergoes a drying process due to a warm air flow being blown onto the front surface of the paper from the treatment liquid drying processing unit 50 which is provided on the inner side of the treatment liquid drying processing drum 46. In other words, the solvent component in the treatment liquid is removed. Accordingly, an ink aggregate layer is formed on the front surface of the paper P.

(Image Recording Section)

The image recording section 18 forms a color image on the printing surface of the paper P by ejecting droplets of inks (aqueous UV inks) of the respective colors of C, M, Y, K onto the printing surface of the paper P. The image recording section 18 is principally constituted by an image recording drum 52 which conveys the paper P, a paper pressing roller 54 which presses the paper P conveyed by the image recording drum 52 and causes the paper P to make tight contact with the circumferential surface of the image recording drum 52, inkjet heads 56C, 56M, 56Y, 56K which eject ink droplets of the respective colors of C, M, Y, K onto the paper P, an in-line sensor 58 which reads out an image recorded on the paper P, a mist filter 60 which captures an ink mist, and a drum cooling unit 62.

The image recording drum 52 receives the paper P from the treatment liquid drying processing drum 46 of the treatment liquid drying processing section 16 and conveys the paper P to the ink drying processing section 20. The image recording drum 52 is formed in a round cylindrical shape and is caused to rotate by being driven by a motor (not illustrated). A gripper 52A is provided on the outer circumferential surface of the image recording drum 52, and the leading end of the paper P is gripped by this gripper 52A. The image recording drum 52 conveys the paper P to the ink drying processing section 20 while the paper P is wrapped about the circumferential surface of the drum, by gripping the leading end of the paper P with the gripper 52A and rotating. Furthermore, a plurality of suction holes (not illustrated) are formed in a prescribed pattern in the circumferential surface of the image recording drum 52. The paper P which is wrapped about the circumferential surface of the image recording drum 52 is conveyed while being held by suction on the circumferential surface of the image recording drum 52, by being suctioned via the suction holes. Consequently, it is possible to convey the paper P with a high degree of flatness.

The suctioning from the suction holes acts only in a fixed range, and acts between a prescribed suction start position and a prescribed suction end position. The suction start position is set at the position where the paper pressing roller 54 is installed, and the suction end position is set on the downstream side of the position where the in-line sensor 58 is installed (for example, a position where the paper is transferred to the ink drying processing section 20). In other words, the suction start and end positions are set in such a manner that the paper P is suctioned and held on the circumferential surface of the image recording drum 52 at least at the position where the inkjet heads 56C, 56M, 56Y, 56K are installed (the image recording position) and the position where the in-line sensor 58 is installed (the image reading position).

The mechanism for suctioning and holding the paper P on the circumferential surface of the image recording drum 52 is not limited to a suctioning method based on negative pressure as described above, and it is also possible to employ a method based on electrostatic suction.

Furthermore, the image recording drum 52 according to the present embodiment is composed in such a manner that grippers 52A are provided in two positions on the outer circumferential surface, whereby two sheets of paper P can be conveyed in one revolution of the drum. The rotation of the image recording drum 52 and the treatment liquid drying processing drum 46 is controlled in such a manner that the reception timing and transfer timing of the paper P are matching. In other words, the drums are driven so as to have the same circumferential speed, and are also driven in such a manner that the positions of the respective grippers match each other.

The paper pressing roller 54 is arranged in the vicinity of the paper reception position on the image recording drum 52 (the position where the paper P is received from the treatment liquid drying processing drum 46). The paper pressing roller 54 is constituted by a rubber roller and is installed so as to be abutted and pressed against the circumferential surface of the image recording drum 52. The paper P which has been transferred from the treatment liquid drying processing drum 46 to the image recording drum 52 is nipped upon passing the paper pressing roller 54 and is thereby caused to make tight contact with the circumferential surface of the image recording drum 52.

The four inkjet heads 56C, 56M, 56Y, 56K are arranged at a uniform spacing apart in the conveyance path of the paper P by the image recording drum 52. These inkjet heads 56C, 56M, 56Y, 56K are constituted by line heads corresponding to the paper width and are arranged in such a manner that that the nozzle surfaces thereof face the circumferential surface of the image recording drum 52. The inkjet heads 56C, 56M, 56Y, 56K record an image on the paper P conveyed by the image recording drum 52, by ejecting droplets of ink toward the image recording drum 52 from the nozzle rows formed on the nozzle surfaces.

The ink ejected from the inkjet heads 56C, 56M, 56Y, 56K employs an aqueous UV ink, as described previously. The aqueous UV ink can be cured by irradiating ultraviolet (UV) light after droplet ejection.

The in-line sensor 58 is provided on the downstream side of the last inkjet head 56K, in the conveyance direction of the paper P by the image recording drum 52, and reads in an image recorded by the inkjet heads 56C, 56M, 56Y, 56K. The in-line sensor 58 is constituted by a line scanner, for example, and reads in an image recorded by the inkjet heads 56C, 56M, 56Y, 56K from the paper P which is conveyed by the image recording drum 52.

A contact prevention plate 59 is provided in the vicinity of the in-line sensor 58, on the downstream side of the in-line sensor 58. This contact prevention plate 59 prevents the paper P from contacting the in-line sensor 58, if floating of the paper P occurs due to conveyance problems, or the like.

The mist filter 60 is arranged between the final inkjet head 56K and the in-line sensor 58, and ink mist is captured by suctioning the air in the periphery of the image recording drum 52. In this way, by capturing the ink mist by suctioning the air in the periphery of the image recording drum 52, it is possible to prevent infiltration of ink mist into the in-line sensor 58 and the occurrence of reading defects, and the like, can be prevented.

The drum cooling unit 62 cools the image recording drum 52 by blowing a cool air flow onto the image recording drum 52. The drum cooling unit 62 is principally constituted by an air-conditioning unit (not illustrated), and a duct 62A which blows the cool air supplied from the air-conditioning unit onto the circumferential surface of the image recording drum 52. The duct 62A cools the image recording drum 52 by blowing cool air onto the region of the image recording drum 52 apart from the conveyance region of the paper P. In the present embodiment, since the paper P is conveyed along the circular arc-shaped surface of substantially the upper half region of the image recording drum 52, the duct 62A cools the image recording drum 52 by blowing cool air onto substantially the lower half region of the image recording drum 52. More specifically, a blowing port of the duct 62A is formed in a circular arc shape so as to cover substantially the lower half of the image recording drum 52, in such a manner that cool air strikes substantially the lower half region of the image recording drum 52.

Here, the temperature to which the image recording drum 52 is cooled is specified in relation to the temperature of the inkjet heads 56C, 56M, 56Y, 56K (in particular, the temperature of the nozzle surface), and the image recording drum 52 is cooled so as to have a temperature lower than the temperature of the inkjet heads 56C, 56M, 56Y, 56K. By this means, it is possible to prevent the occurrence of condensation on the inkjet heads 56C, 56M, 56Y, 56K. More specifically, by making the temperature of the image recording drum 52 lower than the inkjet heads 56C, 56M, 56Y, 56K, it is possible to induce condensation on the image recording drum, and condensation occurring on the inkjet heads 56C, 56M, 56Y, 56K (and in particular, on the nozzle surfaces thereof) can be prevented.

The image recording section 18 has the composition described above. The paper P transferred from the treatment liquid drying processing drum 46 of the treatment liquid drying processing section 16 is received by the image recording drum 52. The image recording drum 52 grips the leading end of the paper P, with the gripper 52A, and by rotating, conveys the paper P. The paper P which has been transferred to the image recording drum 52 passes the paper pressing roller 54 and is thereby caused to make tight contact with the circumferential surface of the image recording drum 52. Simultaneously with this, the paper P is suctioned from the suction holes of the image recording drum 52 and is thereby suctioned and held on the outer circumferential surface of the image recording drum 52. The paper P is conveyed in this state and passes the inkjet heads 56C, 56M, 56Y, 56K. During this passage of the paper P, the inkjet heads 56C, 56M, 56Y, 56K eject droplets of inks of the respective colors C, M, Y, K onto the front surface of the paper P, thereby forming a color image on the front surface. Since an ink aggregate layer is formed on the front surface of the paper P, then it is possible to record an image of high quality without giving rise to feathering or bleeding, or the like.

The paper P on which an image has been recorded by the inkjet heads 56C, 56M, 56Y, 56K then passes the in-line sensor 58. The image recorded on the front surface of the paper is read in while the paper passes the in-line sensor 58. This reading of the recorded image is carried out according to requirements, and inspection for ejection defects, and the like, is carried out on the basis of the read image. The image is read out while in a state of being suctioned and held on the image recording drum 52, and therefore it is possible to read the image with high accuracy. Furthermore, since the image is read immediately after image recording, then it is possible to detect abnormalities, such as ejection defects, straight away, and to take corresponding countermeasures swiftly. Consequently, it is possible to prevent wasteful recording, as well as being able to minimize the occurrence of wasted paper.

Thereupon, the paper P is transferred to the ink drying processing section 20 after cancelling the suction.

(Ink Drying Processing Section)

The ink drying processing section 20 carries out a drying process of the paper P after image recording and removes liquid component remaining on the front surface of the paper P. The ink drying processing section 20 is constituted by a chain gripper 64 which conveys paper P on which an image has been recorded, a back tension application mechanism 66 which applies back tension to the paper P conveyed by the chain gripper 64, and an ink drying processing unit 68 which applies a drying process to the paper P conveyed by the chain gripper 64.

The chain gripper 64 is a paper conveyance mechanism which is used commonly in the ink drying processing section 20, the UV irradiation processing section 22, and the paper output section 24, and it receives paper P transferred from the image recording section 18 and conveys the paper P to the paper output section 24.

This chain gripper 64 is principally constituted by a first sprocket 64A which is provided in the vicinity of the image recording drum 52, a second sprocket 64B which is provided in the paper output section 24, an endless chain 64C which is wrapped about the first sprocket 64A and the second sprocket 64B, a plurality of chain guides (not illustrated) which guide the travel of the chain 64C, and a plurality of grippers 64D which are attached to the chain 64C at a uniform spacing apart. The first sprocket 64A, the second sprocket 64B, the chain 64C and the chain guides are each constituted by pairs, which are arranged on either side in the width direction of the paper P. The grippers 64D are provided so as to span between the pair of chains 64C.

The first sprockets 64A are provided in the vicinity of the image recording drum 52, in such a manner that the paper P received from the image recording drum 52 can be received by a gripper 64D. The first sprockets 64A are axially supported on bearings (not illustrated), and are provided rotatably, as well as being linked to a motor (not illustrated). The chains 64C which are wound about the first sprockets 64A and the second sprockets 64B travel due to the motor being driven.

The second sprockets 64B are provided in the paper output section 24 so as to be able to recover paper P received from the image recording drum 52, in the paper output section 24. In other words, the position at which the second sprockets 64B are provided is the end point of the conveyance path of the paper P by the chain gripper 64. The second sprockets 64B are axially supported on bearings (not illustrated), and are provided rotatably.

The chains 64C are formed in an endless shape and are wrapped about the first sprocket 64A and the second sprocket 64B.

The chain guides are arranged at prescribed positions and guide the chains 64C so as to travel along a prescribed path (namely, so as to convey the paper P by travelling along a prescribed conveyance path). In the inkjet recording apparatus 10 of the present embodiment, the second sprockets 64B are arranged at a higher position than the first sprockets 64A. Therefore, a path of travel is formed in which the chains 64C are inclined in an intermediate portion thereof. More specifically, the conveyance path is constituted by a first horizontal conveyance path 70A, an inclined conveyance path 70B and a second horizontal conveyance path 70C.

The first horizontal conveyance path 70A is set to the same height as the first sprockets 64A, and the chains 64C which are wound about the first sprockets 64A are set so as to travel horizontally.

The second horizontal conveyance path 70C is set to the same height as the second sprockets 64B, and the chains 64C which are wound about the second sprockets 64B are set so as to travel horizontally.

The inclined conveyance path 70B is set between the first horizontal conveyance path 70A and the second horizontal conveyance path 70C, so as to link together the first horizontal conveyance path 70A and the second horizontal conveyance path 70C.

The chain guides are arranged so as to form the first horizontal conveyance path 70A, the inclined conveyance path 70B and the second horizontal conveyance path 70C. More specifically, the chain guides are arranged at least at the junction point between the first horizontal conveyance path 70A and the inclined conveyance path 70B, and at the junction point between the inclined conveyance path 70B and the second horizontal conveyance path 70C.

A plurality of grippers 64D are installed on the chains 64C at a uniform spacing apart. The spacing between the grippers 64D is set in accordance with the reception spacing between paper P received from the image recording drum 52. In other words, this spacing is set to match the reception spacing of the paper P from the image recording drum 52, in such a manner that paper P which is received successively from the image recording drum 52 can be received in synchronous fashion from the image recording drum 52.

The chain gripper 64 has the composition described above. As stated previously, when a motor (not illustrated) which is connected to the first sprockets 64A is driven, the chains 64C travel. The chains 64C travel at the same speed as the circumferential speed of the image recording drum 52. Furthermore, the paper P which is received from the image recording drum 52 is synchronized so as to be received by the respective grippers 64D.

The back tension application mechanism 66 applies a back tension to the paper P which is conveyed while the leading end is gripped by the chain gripper 64. This back tension application mechanism 66 is mainly constituted by a guide plate 72 and a suctioning mechanism 20C which suctions air from suction holes 72A formed in the guide plate 72.

The guide plate 72 is constituted by a hollow-centered box plate having a width corresponding to the paper width. This guide plate 72 is arranged along the conveyance path of the paper P by the chain gripper 64 (namely, the path of travel of the chains). More specifically, the guide plate 72 is arranged along the chains 64C which travel along the first horizontal conveyance path 70A and the inclined conveyance path 70B, and is separated by a prescribed distance from the chains 64C. The paper P conveyed by the chain gripper 64 is conveyed while the rear surface thereof (the surface on the side where an image has not been recorded) slides over the upper surface of the guide plate 72 (the surface opposing the chains 64C; sliding surface).

A plurality of suction holes 72A are formed in a prescribed pattern on the sliding surface (upper surface) of the guide plate 72. As described above, the guide plate 72 is formed by a hollow box plate. The suctioning mechanism 20C suctions the hollow center portion (interior) of the guide plate 72. Consequently, air is suctioned from the suction holes formed in the sliding surface.

By suctioning air from the suction holes of the guide plate 72, the rear surface of the paper P conveyed by the chain gripper 64 is suctioned to the suction holes. Consequently, a back tension is applied to the paper P which is conveyed by the chain gripper 64.

As described above, the guide plate 72 is arranged following the chains 64C which travel in the first horizontal conveyance path 70A and the inclined conveyance path 70B, and therefore a back tension is applied to the paper P while the paper P is conveyed along the first horizontal conveyance path 70A and the inclined conveyance path 70B.

The ink drying processing unit 68 is provided inside the chain gripper 64 (and in particular in the portion which constitutes the first horizontal conveyance path 70A) and carries out a drying process on the paper P which is conveyed along the first horizontal conveyance path 70A. This ink drying processing unit 68 carries out a drying process by blowing a warm air flow onto the front surface of the paper P which is conveyed along the first horizontal conveyance path 70A. A plurality of the ink drying processing units 68 are arranged along the first horizontal conveyance path 70A. The number of units installed is set in accordance with the processing capacity of each ink drying processing unit 68 and the conveyance speed of the paper P (in other words, the printing speed), and so on. More specifically, the number of ink drying processing units 68 is set so as to be able to dry the paper P which is received from the image recording section 18 during the conveyance of the paper P along the first horizontal conveyance path 70A. Therefore, the length of the first horizontal conveyance path 70A is also set in consideration of the capacity of the ink drying processing units 68.

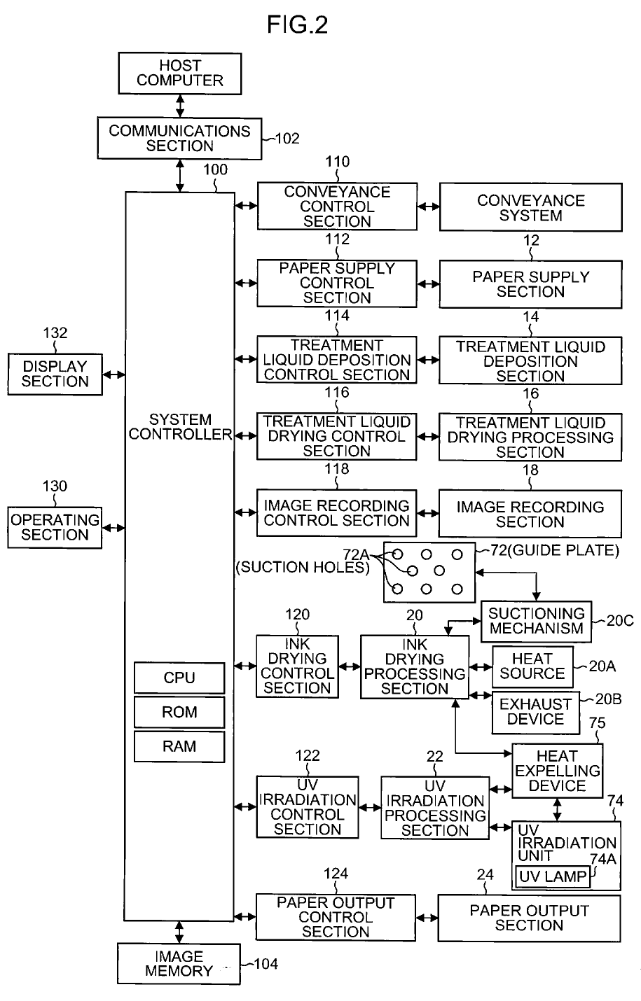

When a drying process is carried out, the humidity of the ink drying processing section 20 rises. When the humidity rises, it becomes impossible to carry out a drying process efficiently, and therefore it is desirable to provide an exhaust device in addition to the ink drying processing units 68 in the ink drying processing section 20, and to forcibly expel humid air which occurs due to the drying process. The exhaust device may be composed by providing an exhaust duct in the ink drying processing section 20, for example, and expelling air in the ink drying processing section 20 by means of this exhaust duct. Incidentally, an example in which an exhaust device 20B for exhausting air is provided is shown in FIG. 2. the exhaust device 20B may include a duct and other devices (fan, for example) for exhausting air.

The ink drying processing section 20 has the composition described above. The paper P transferred from the image recording drum 52 of the image recording section 18 is received by the chain gripper 64. The chain gripper 64 grips the leading end of the paper P, with a gripper 64D, and conveys the paper P along the flat guide plate 72. The paper P which has been transferred to the chain gripper 64 is firstly conveyed along the first horizontal conveyance path 70A. During the course of this conveyance along the first horizontal conveyance path 70A, the paper P undergoes a drying process by the ink drying processing units 68 which are provided inside the chain gripper 64. More specifically, a warm air flow is blown onto the front surface (image recording surface) of the paper, and a drying process is carried out. In this, the paper P undergoes a drying process while receiving a back tension from the back tension application mechanism 66. Consequently, it is possible to carry out a drying process while suppressing deformation of the paper P.

### (UV Irradiation Processing Section)

The UV irradiation processing section 22 irradiates ultraviolet (UV) light onto the image recorded using aqueous UV ink, thereby fixing the image. The UV irradiation processing section 22 is principally constituted by a chain gripper 64 which conveys paper P that has undergone a drying process, a back tension application mechanism 66 which applies back tension to the paper P conveyed by the chain gripper 64, and a UV irradiation unit 74 which irradiates ultraviolet light onto the paper P conveyed by the chain gripper 64.

As described above, the chain gripper 64 and the back tension application mechanism 66 are used commonly in both the ink drying processing section 20 and the output section 24.

The UV irradiation unit 74 is provided inside the chain gripper 64 (and in particular, in the portion constituting the inclined conveyance path 70B) and irradiates ultraviolet onto the front surface of the paper P which is conveyed along the inclined conveyance path 70B. The UV irradiation unit 74 comprises an ultraviolet lamp (UV lamp). A plurality of UV irradiation units 74 are arranged along the inclined conveyance path 70B. The UV irradiation units 74 irradiates ultraviolet light onto the front surface of the paper P which is conveyed along the inclined conveyance path 70B. The number of UV irradiation units 74 installed is set in accordance with the conveyance speed of the paper P (in other words, the printing speed), and the like. More specifically, the number of UV irradiation units 74 is set in such a manner that the image is fixed by the ultraviolet light irradiated while the paper P is conveyed along the inclined conveyance path 70B. Consequently, the length of the inclined conveyance path 70B is also set by taking into account the conveyance speed of the paper P, and the like.

The UV irradiation processing section 22 has the composition described above. The paper P which has been conveyed by the chain gripper 64 and has undergone a drying process in the ink drying processing section 20 is then conveyed along the inclined conveyance path 70B. During the course of this conveyance along the inclined conveyance path 70B, the paper P undergoes a UV irradiation process by the UV irradiation units 74 which are provided inside the chain gripper 64. In other words, ultraviolet light is irradiated onto the front surface from the UV irradiation unit 74. In this, the paper P undergoes a UV irradiation process while receiving a back tension from the back tension application mechanism 66. Consequently, it is possible to carry out a UV irradiation process while suppressing deformation of the paper P. Furthermore, since the UV irradiation processing section 22 is provided in the inclined conveyance path 70B and the inclined guide plate 72 is provided in the inclined conveyance path 70B, then even if the paper P falls from the gripper 64D during conveyance, the paper P is still output by sliding over the guide plate 72.

### (Paper Output Section)

The paper output section 24 recovers paper P on which a series of image recording processes has been carried out. This paper output section 24 is principally constituted by a chain gripper 64 which conveys paper P on which UV light has been irradiated, and a paper output tray 76 on which paper P is stacked and recovered.

As described above, the chain gripper 64 is shared by both the ink drying processing section 20 and the UV irradiation processing section 22. The chain gripper 64 releases the paper P onto the output tray 76 and stacks the paper P on the paper output tray 76.

The output section 76 stacks and recovers paper P which has been released from the chain gripper 64. Paper rails (a front paper rail, rear paper rail, side paper rail, and the like) (not shown) are provided in the output section 76 in such a manner that paper P is stacked in orderly fashion.

Furthermore, the paper output tray 76 is provided raisably and lowerably by means of a paper output tray elevator apparatus, which is not illustrated. The paper output tray elevator apparatus is driven in coordination with increase or decrease in the amount of paper P stacked on the paper output tray 76 and raises and lowers the paper output tray 76 in such a manner that the paper P position at the top of the stack is always at a constant height.

### ((Conveyance System))

FIG. 2 is a block diagram showing the approximate composition of a conveyance system of an inkjet recording apparatus 10 according to the present embodiment.

As shown in FIG. 2, the inkjet recording apparatus 10 includes a system controller 100, a communications section 102, an image memory 104, a conveyance control section 110, a paper supply control section 112, a treatment liquid deposition control section 114, a treatment liquid drying processing section 116, an image recording control section 118, an ink drying control section 120, a UV irradiation control section 122, a paper output control section 124, an operating section 130, a display section 132, and the like.

The system controller 100 functions as a control device which performs overall control of the respective sections of the inkjet recording apparatus 10, and also functions as a calculation device which performs various calculation processes. This system controller 100 includes a CPU, ROM, RAM and the like, and operates in accordance with a prescribed control program. Control programs executed by the system controller 100 and various data necessary for control purposes are stored in the ROM.

The communications section 102 includes a prescribed communications interface, and sends and receives data between the communications interface and a connected host computer.

The image memory 104 functions as a temporary storage device for various data including image data, and data is read from and written to the memory via the system controller 100. Image data which has been read in from a host computer via the

The conveyance control section 110 controls the conveyance system for the paper P in the inkjet recording apparatus 10. In other words, the conveyance control section 110 controls the driving of the tape feeder 36A, the front rail 38 and the paper supply drum 40 in the paper supply section 12, as well as controlling the driving of the treatment liquid deposition drum 42 in the treatment liquid deposition section 14, the treatment liquid drying processing drum 46 in the treatment liquid drying processing section 16, and the image recording drum 52 in the image recording section 18. Furthermore, the conveyance control section 110 controls the driving of the chain gripper 64 and the back tension application mechanism 66 which are used commonly in the ink drying processing section 20, the UV irradiation processing section 22 and the paper output section 24.

The conveyance control section 110 controls the conveyance system in accordance with instructions from the system controller 100, in such a manner that the paper P is conveyed smoothly from the paper supply section 12 to the paper output section 24.

The paper supply control section 112 controls the paper supply section 12 in accordance with the instructions from the system controller 100. More specifically, the driving of the sucker apparatus 32 and the paper supply tray elevator mechanism, and the like, is controlled in such a manner that the paper P stacked on the paper supply tray 30 is supplied successively, one sheet at a time, without overlapping.

The treatment liquid deposition control section 114 controls the treatment liquid deposition section 14 in accordance with the instructions from the system controller 100. More specifically, the driving of the treatment liquid deposition unit 44 is controlled in such a manner that treatment liquid is applied to the paper P conveyed by the treatment liquid deposition drum 42.

The treatment liquid drying control section 116 controls the treatment liquid drying processing section 16 in accordance with the instructions from the system controller 100. More specifically, the driving of the treatment liquid drying processing unit 50 is controlled in such a manner that the paper P conveyed by the treatment liquid treatment liquid drying processing drum 46 undergoes a drying process.

The image recording control section 118 controls the image recording section 18 in accordance with the instructions from the system controller 100. More specifically, the driving of the inkjet heads 56C, 56M, 56Y, 56K is controlled in such a manner that a prescribed image is recorded on the paper P conveyed by the image recording drum 52. Furthermore, the operation of the in-line sensor 58 is controlled in such a manner that the recorded image is read in.

The ink drying control section 120 controls the ink drying processing section 20 in accordance with the instructions from the system controller 100. More specifically, the driving of the ink drying processing units 68 is controlled in such a manner that a warm air flow is blown onto the paper P conveyed by the chain gripper 64.

The UV irradiation control section 122 controls the UV irradiation processing section 22 in accordance with instructions from the system controller 100. More specifically, the driving of the UV irradiation units 74 is controlled in such a manner that ultraviolet light is irradiated onto the paper P conveyed by the chain gripper 64.

The paper output control section 124 controls the paper output section 24 in accordance with instructions from the system controller 100. More specifically, the driving of the paper output tray elevator mechanism, and the like, is controlled in such a manner that the paper P is stacked on the paper output tray 76.

The operating section 130 comprises a prescribed operating device (for example, operating buttons, keyboard, touch panel, and the like), and outputs operating information input via the operating device to the system controller 100. The system controller 100 executes various processing in accordance with the operational information input from the operating section 130.

The display section 132 includes a prescribed display apparatus (for example, an LCD panel, or the like), and causes prescribed information to be displayed on the display apparatus in accordance with instructions from the system controller 100.

As stated previously, image data to be recorded on the paper is read into the inkjet recording apparatus 10 from the host computer via the communications section 102. The image data read in is stored in the image memory 104.

The system controller 100 generates dot data by carrying out prescribed signal processing on the image data stored in the image memory 104. The system controller 100 then controls the driving of the inkjet heads 56C, 56M, 56Y, 56K of the image recording section 18 in accordance with the generated dot data, so as to record an image represented by the image data, on the paper.

In general, the dot data is generated by subjecting the image data to color conversion processing and halftone processing. The color conversion processing is processing for converting image data represented by sRGB, or the like (for example, RGB 8-bit image data) into ink volume data for each color of ink used by the inkjet recording apparatus 10 (in the present embodiment, ink volume data for the respective colors of C, M, Y, K). Halftone processing is processing for converting the ink volume data of the respective colors generated by the color conversion processing into dot data of respective colors by error diffusion processing, or the like.

The system controller 100 generates dot data of the respective colors by applying color conversion processing and halftone processing to the image data. An image represented by the image data is recorded on the paper by controlling the driving of the corresponding inkjet heads in accordance with the dot data for the respective colors thus generated.

((Action))

The action of the inkjet recording apparatus 10 according to the present embodiment which has the composition described above is as follows.

When the system controller 100 is instructed to start a print job via the operating section 130, a cycle up process is carried out. More specifically, preparatory operations are carried out in each section in such a manner that stable operation of the apparatus can be achieved.

When the cycle up has been completed, a printing process is started. In other words, paper P is supplied successively from the paper supply section 12.

In the paper supply section 12, the paper P stacked on the paper supply tray 30 is supplied successively from the top, one sheet at a time, by the sucker apparatus 32. The paper P which has been supplied from the sucker apparatus 32 is loaded onto the feeder board 36, one sheet at a time, via the paper supply roller pair 34.

The paper P loaded on the feeder board 36 receives movement from the tape feeder 36A loaded on the feeder board 36 and is conveyed to the paper supply drum 40 while sliding over the feeder board 36. In this case, the paper P is supplied successively to the paper supply drum 40 while sliding over the feeder board 36 one sheet at a time, without any overlap between the sheets of paper P. Furthermore, during the course of this conveyance, the upper surface of the paper P is pressed against the feeder board 36 by the retainers 36B. By this means, the indentations are corrected.

The leading end of the paper P which has been conveyed to the end of the feeder board 36 is abutted against the front rail 38, the inclination thereof is corrected, and the paper P is then transferred onto the paper supply drum 40. Consequently, it is possible to supply the paper P to the paper supply drum 40 in a constant attitude, without the occurrence of skew.

The paper supply drum 40 receives the paper P by gripping the leading end of the paper P with the gripper 40A while rotating, and conveys the paper P towards the treatment liquid deposition section 14.

The paper P conveyed to the treatment liquid deposition section 14 is received onto the treatment liquid deposition drum 42 from the paper supply drum 40.

The treatment liquid deposition drum 42 receives the paper P by gripping the leading end of the paper P with the gripper 40A while rotating, and conveys the paper P towards the treatment liquid drying processing section 16. During the course of this conveyance by the treatment liquid deposition drum 42, the application roller 44A is abutted and pressed against the front surface of the paper P, thereby depositing (applying) treatment liquid to the front surface of the paper P.

The paper P on the front surface of which treatment liquid has been deposited is transferred from the treatment liquid deposition drum 42 onto the treatment liquid drying processing drum 46.

The treatment liquid drying processing drum 46 receives the paper P by gripping the leading end of the paper P while rotating, and conveys the paper P towards the image recording section 18. The paper P undergoes a drying process while a warm air flow blown from the treatment liquid drying processing unit 50 strikes the front surface of the paper P during the conveyance thereof by the treatment liquid drying processing drum 46. By this means, the solvent component in the treatment liquid is removed and an ink aggregate layer is formed on the front surface of the paper P (the image recording surface).

The paper P which has undergone a treatment liquid drying process is received onto the image recording drum 52 from the treatment liquid drying processing drum 46.

The image recording drum 52 receives the paper P by gripping the leading end of the paper P while rotating, and conveys the paper P towards the ink drying processing section 20. An image is recorded by ejecting droplets of inks of the respective colors of C, M, Y, K onto the front surface of the paper P by the inkjet heads 56C, 56M, 56Y, 56K, while the paper P is conveyed by the image recording drum 52. Furthermore, the image recorded in the course of this conveyance is read in by the in-line sensor 58. In the course of this, the paper P is conveyed while being suctioned and held on the circumferential surface of the image recording drum 52. Thus, the processes of image recording and reading of the recorded image are carried out with the paper in this suctioned and held state. By this means, it is possible to record an image with high accuracy, as well as being able to read in the image with high accuracy.

The paper P on which an image has been recorded is transferred from the image recording drum 52 to the chain gripper 64.

The chain gripper 64 grips the leading end of the paper P with the gripper 64D provided on the traveling chain 64C, receives the paper P, and conveys the paper P towards the paper output section 24.

Firstly, the paper P undergoes an ink drying process during the course of this conveyance by the chain gripper 64. In other words, a warm air flow is blown towards the front surface of the paper P from the ink drying processing units 68 which are provided in the first horizontal conveyance path 70A. By this means, a drying process is carried out. In this case, the paper P is conveyed while the rear surface is suctioned and held by the guide plate 72, and hence a back tension is applied to the paper P. Consequently, it is possible to carry out a drying process while suppressing deformation of the paper P.

The paper P which has completed a drying process (the paper P which has passed through the ink drying processing section 20) then undergoes a UV irradiation process. In other words, ultraviolet light is irradiated onto the front surface of the paper P from the UV irradiation units 74 which are provided in the inclined conveyance path 70B. Thereby, the ink which forms the image is cured and the image is fixed onto the paper P. In this case, the paper P is conveyed while the rear surface is suctioned and held by the guide plate 72, and hence a back tension is applied to the paper P. Consequently, it is possible to carry out a fixing process while suppressing deformation of the paper P.

The paper P which has completed a UV irradiation process (the paper P which has passed the UV irradiation processing section 22) is conveyed towards the paper output section 24, released by the gripper 64D in the paper output section 24, and stacked on top of the paper output tray 76.

An image recording process is completed by the series of operations described above. As stated previously, since the paper P is supplied consecutively from the paper supply section 12, then these consecutively supplied sheets of paper P are processed consecutively in the respective sections and an image recording process is carried out thereon.

As described above, according to the inkjet recording apparatus 10 of the present embodiment, paper P on which an image has been recorded is received from the image recording section 18 by the chain gripper 64, and an ink drying process and a UV irradiation process are carried out during the course of this conveyance by the chain gripper 64. In the chain gripper 64, the paper conveyance path can be set freely and the ink drying processing units 68 and the UV irradiation units 74 can be arranged at high density. Consequently, the paper P after image recording can be dried rapidly and efficiently, and the ink can be dried before penetrating into the paper P. Accordingly, it is possible to suppress deformation of the paper P. Similarly, the paper P can also be processed efficiently with a short UV irradiation time.

Moreover, since a drying process and a UV irradiation process are carried out by a conveyance device (in the present embodiment, the chain gripper 64) which is separate from the conveyance device for image recording (in the present embodiment, the image recording drum 52), then it is possible to suppress increase in the temperature of the conveyance device for image recording due to the heat generated during the drying process and the UV irradiation process. Consequently, it is possible effectively to prevent the occurrence of condensation in the inkjet head or the acceleration of drying of the nozzles.

Furthermore, in the inkjet recording apparatus 10 according to the present embodiment, since a composition is adopted in which a back tension is applied to the paper P when carrying out the drying process and the UV irradiation process, it is possible to carry out the drying process and the UV irradiation process while suppressing deformation in the paper P.

Moreover, in the inkjet recording apparatus 10 according to the present embodiment, an in-line sensor 58 is provided in an image recording section 18, and image reading is carried out immediately after image recording. Therefore, it is possible to determine ejection defects, and the like, swiftly, on the basis of the image recording results. Consequently, it is possible to respond rapidly when an ejection defect, or the like, has been detected, and the occurrence of wasted paper, and the like, can be suppressed effectively.

Furthermore, since a composition is adopted in which the image is read in a state where the paper is held on an image recording drum 52 (the same state as during image recording), then it is possible to carry out image reading with high accuracy. More specifically, when the image is read in after removing the paper P from the image recording drum 52, the state of the paper changes and there is a risk of it becoming impossible to read the image with high accuracy, but since image reading is carried out while the paper is held on the image recording drum 52, then the image can be read in without any change in the state of the paper P, and image reading can be performed with high accuracy. In particular, in the inkjet recording apparatus 10 according to the present embodiment, since the paper P is conveyed while being suctioned and held on the circumferential surface of the image recording drum 52, then it is possible to read in the image with high accuracy.

### Other Embodiments

In the embodiment described above, a composition is adopted in which a drying process is carried out in the ink drying processing section 20 by blowing a warm air flow onto the front surface of the paper P, but it is also possible to adopt a composition in which a drying process is carried out by heating the paper P through radiation from a heater (for example, an infrared heater). Furthermore, it is also possible to combine a drying process by heating and drying by warm air blowing.

By using a heat source 20A which heats the pigment or dye of the aqueous UV ink, as the heat source which is used for heating, it is possible to restrict deformation of the paper P which occurs due to heating the paper P. For example, it is possible to use a NIR lamp (near-infrared lamp) or an IR-LED, as the heat source.

Furthermore, the UV lamp 74A used in the UV irradiation units 74 of the UV irradiation processing section 22 can employ a mercury lamp, a metal hydride lamp, an LED, or the like, but it is desirable to use an ozone-less type of lamp. This can prevent the generation of harmful ozone.

Moreover, if using an ozone-less type of UV lamp 74A, it is desirable to expel the heat produced by the UV lamp, to the ink drying processing section 20, so as to contribute to the drying process. Consequently, it is possible to carry out a drying process efficiently, while restricting power consumption. In this case, it is possible to adopt a composition which blows the heat generated by the UV irradiation processing section 22, via a duct, to the ink drying processing section 20 (by a fan, for example). Incidentally, an example in which a heat expelling device 75B for carrying out such heat expelling process is provided is shown in FIG. 2. The heat expelling device 75B may include a fan, a duct, and other devices for driving the fan and the duct.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An inkjet recording apparatus, comprising:
an image recording section which records an image on a front surface of a cut sheet recording medium by an inkjet method using an aqueous ink;
a chain gripper which receives the recording medium, on the front surface of which an image has been recorded, from the image recording section, and conveys the recording medium by gripping a leading end of the received recording medium; and
a drying processing section which carries out a drying process on the recording medium conveyed by the chain gripper.

2. The inkjet recording apparatus as defined in claim 1, further comprising a UV irradiation processing section which carries out a UV irradiation process after the drying process on the recording medium conveyed by the chain gripper,
wherein the aqueous ink used in the image recording section is a UV-curable type of aqueous ink.

3. The inkjet recording apparatus as defined in claim 1, further comprising a back tension application device which applies a back tension to the recording medium conveyed by the chain gripper.

4. The inkjet recording apparatus as defined in claim 3, wherein
the back tension application device comprises:
a guide plate which is arranged along a conveyance path of the recording medium conveyed by the chain gripper, and over which a rear surface of the recording medium conveyed by the chain gripper slides, and which has a plurality of suction holes in the sliding surface over which the recording medium slides; and
a suctioning device which suctions the rear surface of the recording medium that slides over the sliding surface of the guide plate, by suctioning air from the suction holes of the guide plate.

5. The inkjet recording apparatus as defined in claim 1,
wherein the drying processing section comprises:
a drying process device which carries out a drying process on the recording medium, by heating and/or a warm air flow; and
an exhaust device.

6. The inkjet recording apparatus as defined in claim 5, wherein the drying processing section carries out a drying process on the recording medium by using a heat source which heats only a pigment or dye in the aqueous ink.

7. The inkjet recording apparatus as defined in claim 2, further comprising a heat expelling device which expels heat generated by a UV light source of the UV irradiation processing section, to the drying processing section.

8. The inkjet recording apparatus as defined in claim 7, wherein the UV irradiation processing section uses an ozone-less type light source.

9. The inkjet recording apparatus as defined in claim 2, wherein the drying processing section and the UV irradiation processing section are arranged inside the chain gripper.

10. The inkjet recording apparatus as defined in claim 1, wherein
the image recording section comprises:
a conveyance drum which suctions and holds the recording medium on a circumferential surface of the conveyance drum and conveys the recording medium; and
an inkjet head which records an image by ejecting the aqueous ink onto a front surface of the recording medium which is conveyed by the conveyance drum, and
wherein
the chain gripper receives the recording medium from the conveyance drum.

11. The inkjet recording apparatus as defined in claim 10, wherein the image recording section further comprises an image reading device which reads an image recorded on the front surface of the recording medium by the inkjet head.

12. The inkjet recording apparatus as defined in claim 11, wherein the image recording section further comprises a mist filter provided between the inkjet head and the image reading device.

13. The inkjet recording apparatus as defined in claim 10, wherein the image recording section further comprises a cooling device which cools the conveyance drum.

14. The inkjet recording apparatus as defined in claim 1, further comprising:
a treatment liquid deposition section which deposits a treatment liquid having a function of aggregating coloring material in the aqueous ink, on the front surface of the recording medium; and
a treatment liquid drying processing section which carries out a drying process on the recording medium on which the treatment liquid has been deposited, wherein
the image recording section receives the recording medium on which a drying process has been carried out by the treatment liquid drying processing section, and records an image thereon by an inkjet method in use of the aqueous ink.
